(19) United States
(12) Patent Application Publication
(10) Pub. No.: US 2007/0123346 A1
(43) Pub. Date: May 31, 2007

(54) SYSTEM AND METHOD FOR IMPROVED CASINO PROMOTIONAL MESSAGING

(76) Inventors: Debra J. Perez, Las Vegas, NV (US); Lattamore D. Osburn, Las Vegas, NV (US); Scott Dickerson, Henderson, NV (US); Janae Hoover, Henderson, NV (US)

Correspondence Address: MCANDREWS HELD & MALLOY, LTD, 500 WEST MADISON STREET, SUITE 3400, CHICAGO, IL, 60661, US

(21) Appl. No.: 11/531,012

(22) Filed: Sep. 12, 2006

Related U.S. Application Data
(60) Provisional application No. 60/716,392, filed on Sep. 13, 2005.

(51) Int. Cl. A63F 9/24; A63F 13/00

(52) U.S. Cl. 463/29

(57) ABSTRACT

Certain embodiments provide a system and method for improved promotional messaging for a gaming environment. Certain embodiments include a method for improved promotional broadcast messaging. The method includes composing a promotional message for a gaming environment; selecting one or more recipients for the promotional message; associating contact information with one or more recipients; relaying the promotional message with the recipient contact information for broadcasting; and broadcasting the promotional message to one or more recipients using the recipient contact information. In an embodiment, the contact information comprises a cellular phone number, for example. The method may also include generating a status message when the promotional message is delivered to a communication device associated with the recipient contact information. In addition, the method may include generating a report based on the promotional message. Furthermore, the method may include editing, deleting, resending and/or recalling the promotional message, for example.

### RELATED APPLICATIONS

The present application relates to, and claims priority from, U.S. Provisional Application No. 60/716,392, filed on Sep. 13, 2005, entitled “System and Method for Improved Casino Promotional Messaging,” which is herein incorporated by reference in its entirety.

### BACKGROUND OF THE INVENTION

This invention relates to promotions in a gaming environment, and more particularly relates to a system and method for promotional messaging and management in a gaming environment.

Gaming machines, such as slot machines, fruit machines, or poker machines, have in recent years become one of the more popular, exciting, and sophisticated wagering activities available at casinos and other gambling locations. At the same time, gaming machines have also become a source of greater revenue for gaming establishments. Thus, competition between manufacturers of gaming machines has intensified as competitors vie for business from gaming establishments.

large gaming casino typically employs thousands of gaming machines that can be operated simultaneously. A gaming system providing entertaining and enticing features for players would be highly desirable to attract both new and returning players to a gaining establishment. Additionally, casinos and other gaining environments often arrange promotions or other events to attract new customers and provide additional incentives for recurring customers.

Traditionally, casinos use a variety of printed methods to inform patrons of promotional events. For example, bulk mailing advertisements, newspaper adds, advertisement posters, flyers, billboards, etc. are used to advertise promotional events. However, several drawbacks are associated with traditional print marketing. First, typical casino marketing campaigns involve primarily manual processes. Delivery of information is time consuming and dependent on the manual processes. Thus, a patron often received promotional information after the promotional event has occurred. Second, costs associated with the manual processes for providing promotional information to the patron are extremely high. Third, casinos rely on third parties, such as a post office, to distribute promotional information to patrons. Problems occurring with respect to the third parties are outside the control of the casino. However, third party problems often cause a casino's promotional information not to be distributed to patrons. Reliance on external partners also limits casinos from doing impromptu promotions.

Thus, there is a need for a system and method that allows improved, flexible distribution of promotional information to casino patrons.

### BRIEF SUMMARY OF THE INVENTION

Certain embodiments provide a system and method for improved promotional messaging for a gaming environment. Certain embodiments provide an improve promotional messaging system that includes a workstation configured to compose a promotional message for a gaming establishment and a message relay station for broadcasting the promotional message from the workstation to a registered communication device. In an embodiment, the system further includes a communication device capable of receiving the message and displaying the message to a registered patron. The communication device may be a promotion notification device assigned to a patron by a gaming establishment, for example.

In an embodiment, the system also includes a server configured to store the promotional message. The server may include a database for storing the promotional message, for example. The workstation may be capable of generating a report using the promotional message stored at the server, for example. In an embodiment, the workstation is configured to allow an authorized user to edit and/or remove the promotional message before the promotional message is broadcast to the communication device. The workstation may also be configured to allow an authorized user to remove, edit and/or resend a promotional message that has previously been broadcast, for example.

Certain embodiments include a promotional notification device including a receiver for receiving a promotional message from a gaming environment relay station, a display for displaying the promotional message, and an alert indicator for alerting a user to receipt of the promotional message, for example. The alert indicator may include an audio alert indicator, a visual alert indicator, and/or a vibrating alert indicator, for example. In an embodiment, the promotional notification device may also include a scrolling arrow or other button or icon capable of allowing a user to scroll through a message displayed on the display.

Certain embodiments provide a computer-readable medium including a set of instructions capable of execution by a computer. The set of instructions includes a message composition routine for composing a message for broadcast to at least one participating patron, wherein the message comprises a gaming promotional message. The set of instructions also includes a message broadcasting routine for retrieving communication information for the at least one participating patron and transmitting the message to the at least one participating patron using the communication information. The set of instructions may also include a messaging editing routine for at least one of editing, removing, recalling and resending the message. Additionally, the set of instructions may include a reporting routine for generating a report based on the message. In an embodiment, the report includes a broadcast messaging report, a player promotional messaging report, a promotional group report, an audit report and/or an error report, for example.

Certain embodiments include a method for improved promotional broadcast messaging. The method includes composing a promotional message for a gaining environment; selecting one or more recipients for the promotional message; associating contact information with one or more recipients; relaying the promotional message with the recipient contact information for broadcasting; and broadcasting the promotional message to one or more recipients using the recipient contact information. In an embodiment, the contact information comprises a cellular phone number, for example. The method may also include generating a status message when the promotional message is delivered to a communication device associated with the recipient contact information. In addition, the method may include generating a report based on the promotional message. Furthermore, the method may include editing, deleting, resending and/or recalling the promotional message, for example.

### BRIEF DESCRIPTION OF THE DRAWINGS

FIG. 1 depicts a promotional messaging system in accordance with an embodiment of the present invention.

FIG. 2 illustrates a flow diagram for a method for promotional messaging used in accordance with an embodiment of the present invention.

FIG. 3 illustrates a flow diagram for a method and system for player promotion messaging used in accordance with an embodiment of the present invention.

FIG. 4 shows an example of a message composition interface screen used in accordance with an embodiment of the present invention.

FIG. 5 depicts a flow diagram for a method and system for promotion messaging report generation used in accordance with an embodiment of the present invention.

FIG. 6 shows an example of a promotion notification device used in accordance with an embodiment of the present invention.

FIG. 7 shows an example of a promotion notification device used in accordance with an embodiment of the present invention.

FIG. 8 illustrates a flow diagram for a system and method for promotion messaging used in accordance with an embodiment of the present invention.

FIG. 9 illustrates a flow diagram for a method and system for report generation used in accordance with an embodiment of the present invention.

### DETAILED DESCRIPTION OF THE INVENTION

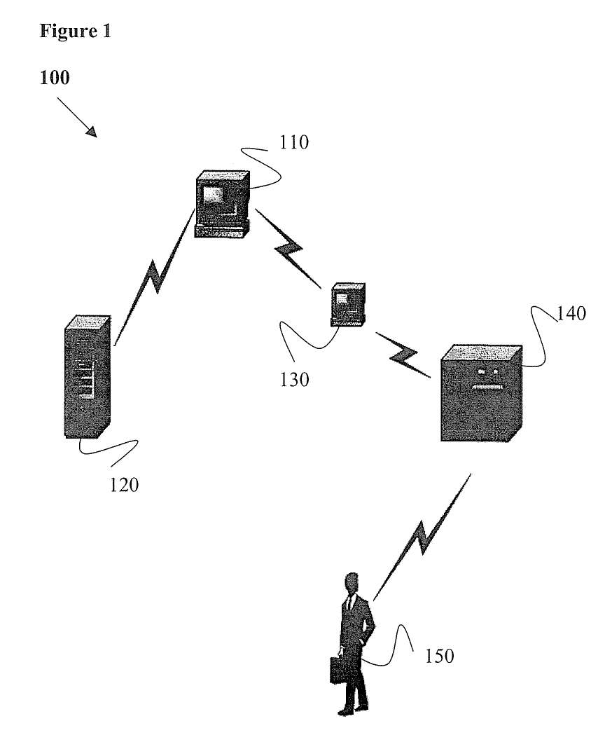

FIG. 1 depicts a promotional messaging system 100 in accordance with an embodiment of the present invention. The system 100 includes a workstation 110, a server 120, an interface 130, a communication hub 140, and a communication device 150. The components of the system 100 may be implemented in software and/or in hardware and may be separate and/or integrated in various forms, for example. The components of the system 100 communicate via wired and/or wireless networks or connections, for example.

The workstation 110 includes an interface, such as a menu-driven interface, to allow a user to compose, edit, transmit, and/or analyze promotional messages and other messages for a gaming environment, such as a casino. The workstation may be implemented as a personal computer workstation, for example. In an embodiment, the workstation 110 is a Super-PlayMate™ workstation running OASIS™ Super-PlayMate™ software for composing and sending promotional messages.

The workstation 110 allows a user to enter a promotional message for communication to a patron. For example, the OASIS™ Super-PlayMate™ workstation includes a “create a promotional message” menu option to allow an authorized user to create a message. In an embodiment, the workstation 110 may authenticate a user before allowing the user to create a message and/or utilize other features of the workstation 110. In an embodiment, users enter a message title and a date and time at which the message is to be sent and selects a promotional group identifier or individual patron to receive the message. The user enters the content of the message, such as plain text, rich text, graphical content, HTML content, XML content, or other content, and may edit or delete content in a message until the message is sent. The message is saved at the workstation 110 for transmittal to the server 120 and/or interface 130, for example. In an embodiment, a message saved at the workstation 110 is transmitted to the interface 130 at a time defined when the message is entered.

The server 120 may be an OASIS™ casino management server or other server, for example. The server 120 includes a database or other data store capable of storing records of promotional messages and other data, for example. The server 120 includes a record of promotional messages that have been created, edit and/or deleted, for example. The records allow reports to be generated using the message data. Additionally, the server 120 may include records of players and/or other patrons with promotional group ID information, for example. Patron records may be used to generate reports regarding promotional group statistics and/or effectiveness, for example.

The interface 130 may be a gateway interface or other network communication interface permitting interactivity between the workstation 110 and the communication hub 140, for example. The interface 130 receives a message from the workstation 110. The interface 130 retrieves phone number(s) and/or other communication information for delivery of the message to intended recipient(s), for example. The interface 130 transmits the message and phone number(s) and/or other communication information to the communication hub 140 for delivery of the message.

The communication hub 140 may be a private branch exchange (PBX) hub or other telephone/Internet switching equipment, for example. The hub 140 dials the phone number(s) received from the interface 130 and sends the message or otherwise routes the message based on the provided contact information. In an embodiment, the hub 140 returns a status message to the interface 130 regarding success or failure of message delivery. The interface 130 may update the workstation 110 and/or the server 120 with message delivery and/or error status, for example.

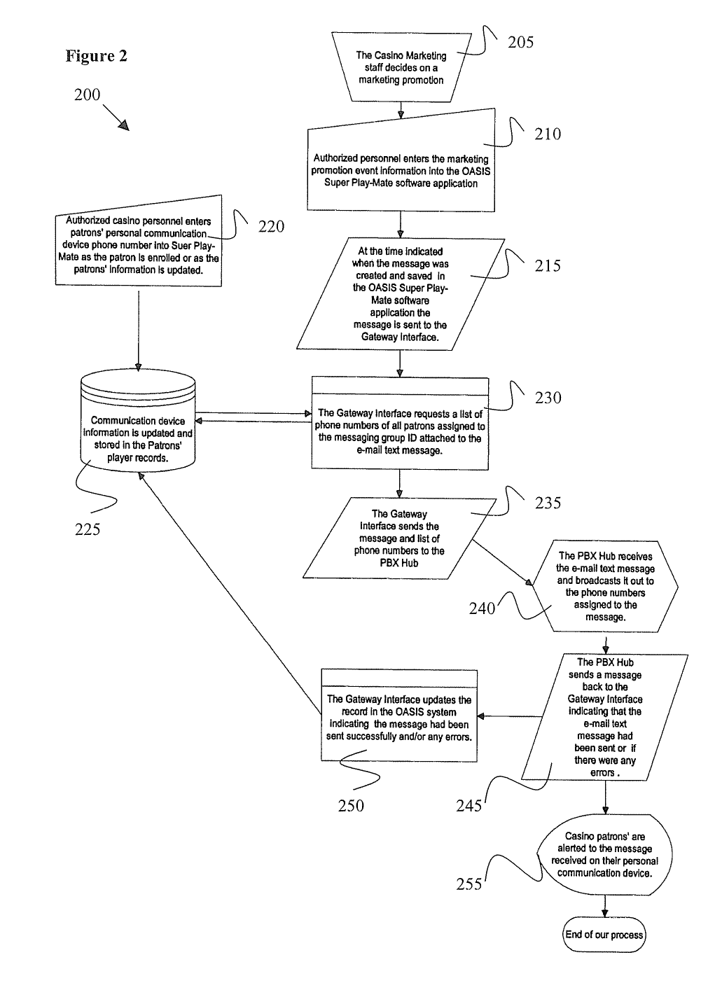

FIG. 2 illustrates a flow diagram for a method 200 for promotional messaging used in accordance with an embodiment of the present invention. First, at step 205, a casino or other gaming environment marketing promotion is determined by, for example, a casino marketing staff. Then, at step 210, information regarding the promotion event is entered. For example, authorized casino personnel enter marketing promotion event information into an OASIS™ Super-PlayMate™ software application. For example, casino personnel may use a menu application to create a promotional message. In an embodiment, parameters, such as messaging time, recipients, and/or other information may be configured for the promotion. The promotional message may be saved in a software application or electronic memory, for example. A patron may be assigned to a promotional group ID or other identifier with respect to a player profile. Next, at step 215, the promotion message is transmitted to a communication gateway interface. For example, at a time indicated when the message was created and saved in the OASIS™ Super-PlayMate™ software application, the message is sent to the gateway interface.

At step 220, communication information, such as a cell phone number, is entered to enroll a user or update the user's information. For example, authorized casino personnel enter a patron's personal communication device phone numbers into Super Play-Mate™ as the patron as enrolled or as the patron's information is updated. Then, at step 225, communication information is updated and stored in a player record. The player record may be a casino, group and/or individual player record, for example.

Next, at step 230, a list of communication information is requested for a particular promotion message group. For example, the gateway interface requests a list of phone members for all patrons assigned to the message group ID attached to the promotion e-mail text message. Then, at step 235, the promotion message and a list of relevant communication information is sent to a private branch exchange (PBX) hub, for example. For example, the gateway interface sends the promotion message and a list of relevant phone numbers to the PBX hub or other private telephone network. At step 240, the promotion message is received by the PBX hub and broadcast according to the communication information associated with the message. For example, the PBX hub receives the e-mail promotional message and broadcasts it to the phone members assigned to the message.

At step 245, a status message is returned indicating the status of promotion message transmission. For example, the PBX hub sends a message back to the gateway interface indicating that the promotion e-mail message has been transmitted or indicating any errors that occurred during the transmission of the message. Then, at step 250, records are updated based on promotion message transmission status. For example, the gateway interface updates the record in the OASIS™ system indicating that the message has been sent successfully and/or error(s) had occurred. In an embodiment, the OASIS™ or other casino management or slot accounting system includes a record of every promotional message created, edited and/or deleted, for example. Records may be reviewed to identify promotional messages and determine effectiveness of promotional messages, for example. In an embodiment, authorized personnel may delete and/or edit a message that has been created as long as the message has not yet been sent. At step 255, users are alerted to the received message. For example, casino patrons are alerted to the promotional message received on their personal communication devices.

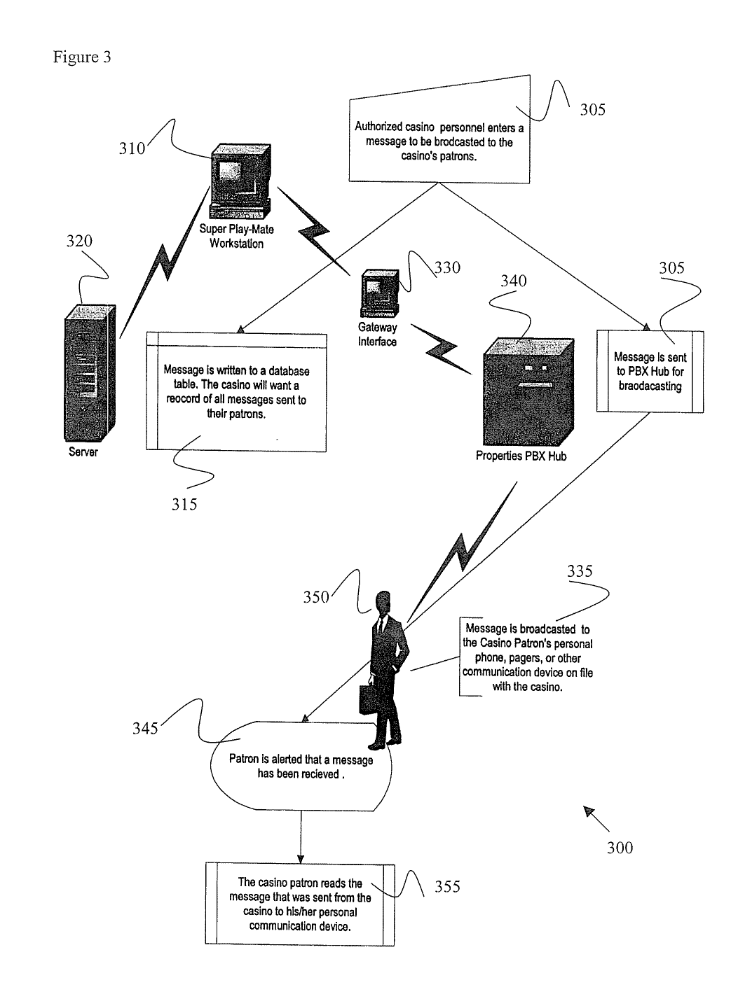

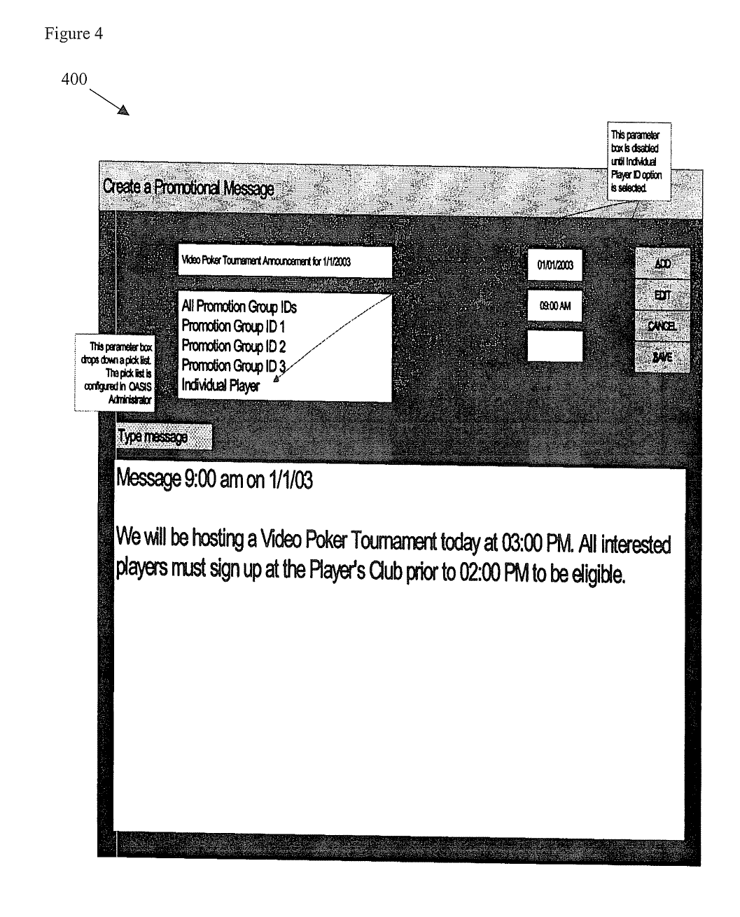

FIG. 3 illustrates a flow diagram for a method and system 300 for player promotion messaging used in accordance with an embodiment of the present invention. First, at step 305, a message is compiled for broadcast. For example, authorized casino personnel enter a message at a workstation 310, such as a Super Play-Mate™ workstation, to be broadcast to casino patrons. An example of a message composition interface screen is illustrated in FIG. 4. At step 315, the message is written to a database table or other data structure/memory, for example. For example, the message is stored in a database residing on a server 320 to allow a casino or other gaming establishment to record message sent to patrons. Then, at step 325, the message is transmitted to a PBX hub 340 for broadcasting. For example, the message is sent to the PBX hub 340 for a gaming environment via a gateway interface 330. Next, at step 335, the message is broadcast to one or more communication devices. For example, the message is broadcast to a personal phone, pager, personal digital assistant, or other communication device 350 on file with a casino. At step 345, a user is alerted that a message has been received. Then, at step 355, the user reads the message. For example, the casino patron reads the promotional message that was sent from the casino to his/her personal communication device 350. In an embodiment, status of a message transmission may be reported and stored at the server 320 and/or workstation 310.

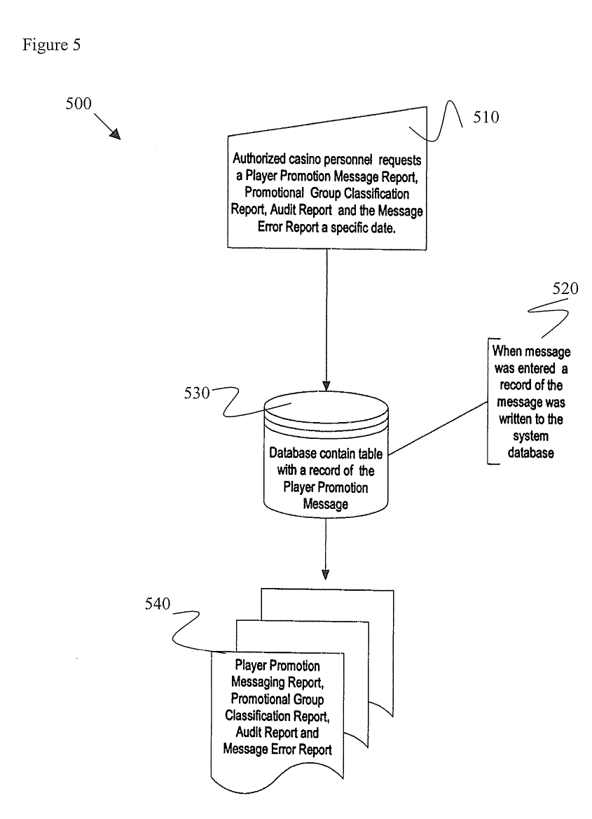

FIG. 5 depicts a flow diagram for a method and system 500 for promotion messaging report generation used in accordance with an embodiment of the present invention. First, at step 510, a report is requested. For example, authorized casino personnel may request a player promotion message report, a promotional group classification report, an audit report, a message error report and/or another report for a specific date, patron, group, range, or other criterion, for example. At step 520, when a promotion message was entered, a record of the message was written to a system database 530. The database 530 includes one or more tables or other data structures with record(s) of message(s), such as player promotion messages. Then, at step 540, a report is generated from data in the database 530. For example, a player promotion messaging report shows all promotion messages created within a specified data range, such as a date range, recipient list, or other criterion. The report includes a date and time a message was entered, a date and time the message is to be sent to a patron, a user who entered the message, and/or a status of the message (e.g., pending, sent, deleted), for example. A promotional group classification report details players associated with one or more promotional group IDs, for example. The report may be generated for all promotional groups and/or a specific promotional group, for example. An audit report details any changes made to a message after the message has been entered. The report may include information such as a date and time that the message was changed, a user who changed the message, and/or content in the message that was changed. A message error report details errors, such as errors reported by the PBX hub and/or gateway interface regarding message delivery. In an embodiment, data from the database 530 may be combined with other information to generate a report.

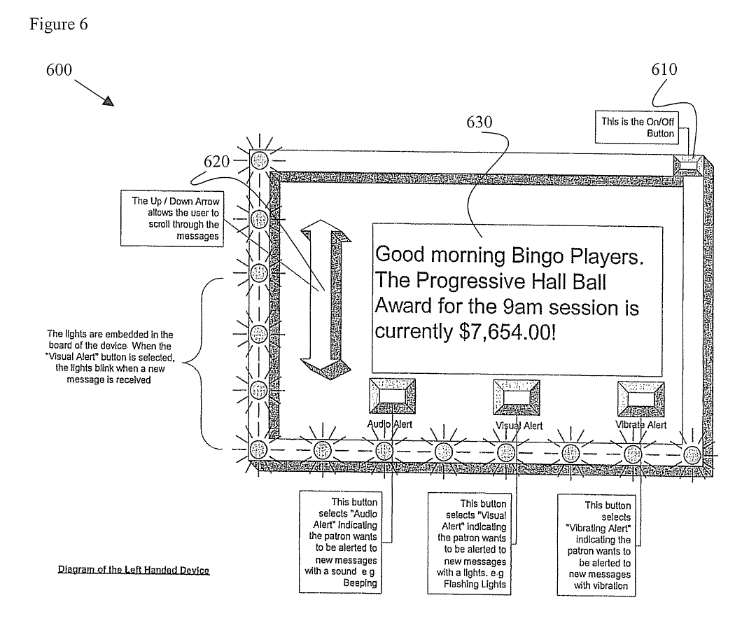

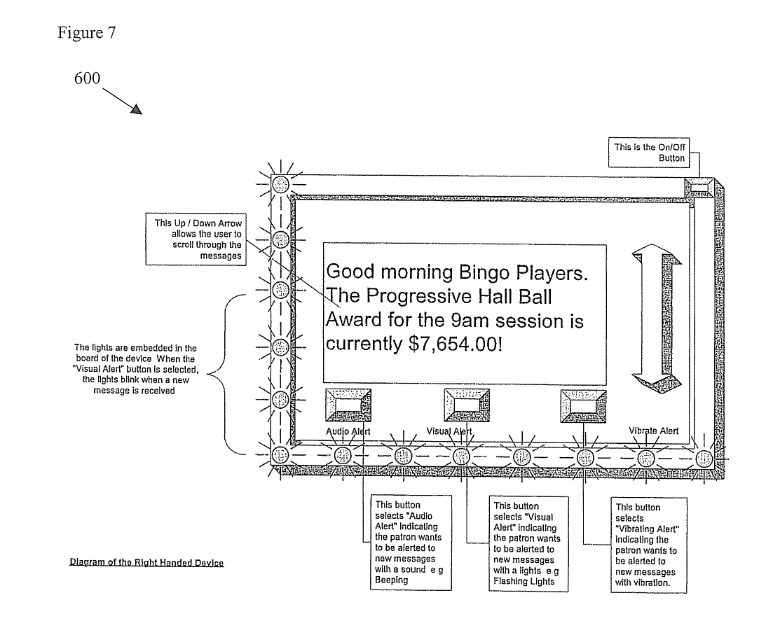

In certain embodiments, casinos and/or other gaining environments may provide patrons with promotion notification devices capable of receiving promotional and other messages from the casino. Examples of promotional notification devices are shown in FIGS. 6 and 7, for example. FIGS. 6 and 7 show left-handed (FIG. 6) and right-handed (FIG. 7) versions of promotion notification device 600. In certain embodiments, the notification device 600 includes an on/off button 610 to allow a user to turn the device on or off. The device 600 may include a scroll bar 620 and/or up/down arrow to allow a user to move through a message or messages displayed on a screen 630, such as an LCD screen or other display, integrated in the promotion device 600. The promotion notification device 600 receives a message from a system, such as the promotion messaging system 100, and displays the message upon receipt or upon selection by the user. The user is alerted to receipt of the message at the device 600. The device 600 may receive a message via a cellular network, infrared connection, and/or other wireless connection, for example.

The promotion notification device 600 includes one or more alert options, such as audio alert, visual alert, and/or vibrate alert. In an embodiment, the device 600 includes audio, visual and vibrate alerts selectable by a user. If the audio alert option is selected, the patron is alerted to a new message by a beeping sound, music, or verbiage recorded for the message broadcast, for example. If the visual alert option is selected, the patron is alerted to a new message by blinking or flashing lights or other visual indicator, for example. If the vibrate alert option is selected, the patron is alerted to a new message by vibration of the notification device 600. In an embodiment, the device 600 may further include a delete button to enable a user to delete a message from memory in the device 600.

The promotion notification device 600 is assigned to an individual patron and may be used in conjunction with the system 100 or other messaging system to provide transmitted messages to the patron. The device 600 may be provided to patrons free of charge by a gaming environment upon enrollment in a mailing list or other promotional program or may be provided for a fee, for example. Each promotion notification device 600 has a unique communication address or group communication address to allow for individualized and/or group messaging, for example.

In an embodiment, patrons are assigned to and/or may select one or more promotional groups based on promotional message or activity type, for example. Using promotional groups for message generation and transmission may reduce possible customer complaint issues arising from patrons receiving promotional messages for which they are not interested. In an embodiment, a user may define an amount of time that a message is displayed at the device 600. In an embodiment, after the period of time has expired, the message may be automatically deleted or may be removed from the display 630 to be accessed by a menu from the device 600.

The promotion messaging device 600 works with a promotion messaging system, such as the system 100 or other similar system, to display promotional message content to a patron. The promotion messaging system includes a central workstation for adding, removing, editing, saving and/or sending messages for transmission to devices 600. In an embodiment, a user logs in or is authenticated in order to access the workstation. The workstation may be used to generate a uniform message to be sent to all patrons with messaging devices 600 and/or specialized messages for individual patrons and/or groups (e.g., promotional groups) of patrons, for example. Additionally, the workstation may be used to remove, edit and/or resend messages that have previously been broadcast. The workstation may also be used to add, edit and/or remove promotional group classifications and/or patrons within promotional group classifications.

Authorized personnel may create messages in advance of the date and time that the messages are to be broadcast. Reports may be generated pertaining to messages that have already been broadcast, are waiting to be broadcast, have been edited, and/or have been deleted, for example. Additionally, reports may be generated regarding adding, editing, and removal of promotional groups and/or patrons, for example. In an embodiment, the system may record transmissions on an individual patron's account to monitor responses, for example.

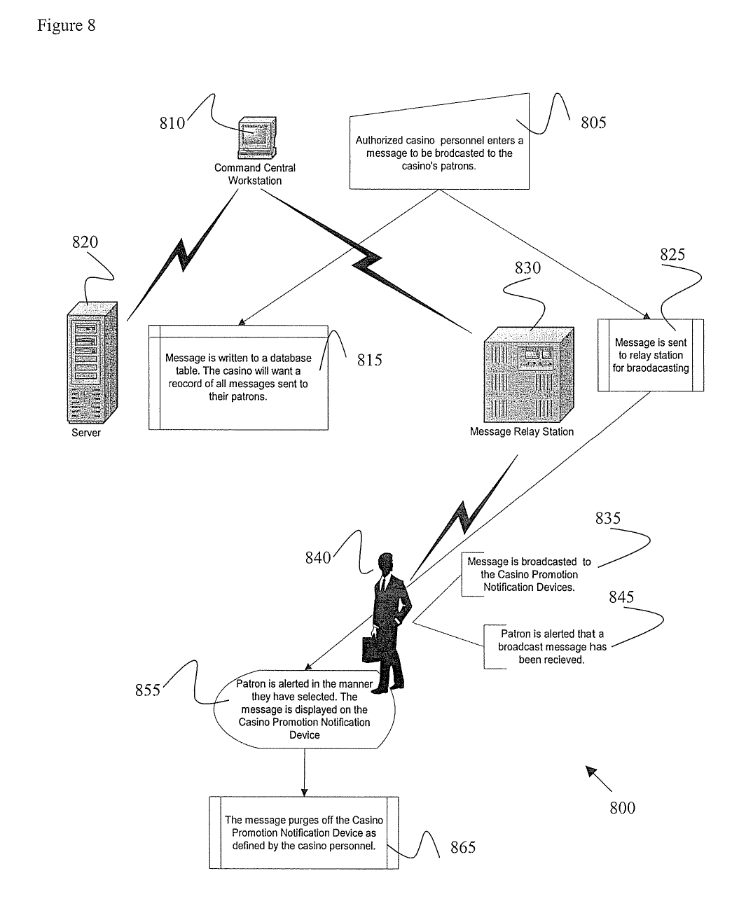

FIG. 8 illustrates a flow diagram for a system and method 800 for promotion messaging used in accordance with an embodiment of the present invention. First, at step 805, a message is entered for broadcast to participating patron(s). The message may be entered by authorized personnel using a command central workstation 810, for example. Then, at step 815, the message is written to a database. The database may be stored on a server 820, for example. At step 825, the message is sent for broadcasting. The message may be sent to a message relay station 830 for broadcasting, for example. Next, at step 835, the message is broadcast to a promotion notification device 840. The promotion notification device 840 may be similar to the device 600, for example. Then, at step 845, the patron is alerted that a broadcast message has been received. The patron is alerted in the manner that has been selected, such as audio, visual and/or vibrating alert. At step 855, the message is displayed on the promotion notification device 840. Then, at step 865, the message is purged from the notification device 840 according to parameter(s) defined by authorized personnel and/or the patron.

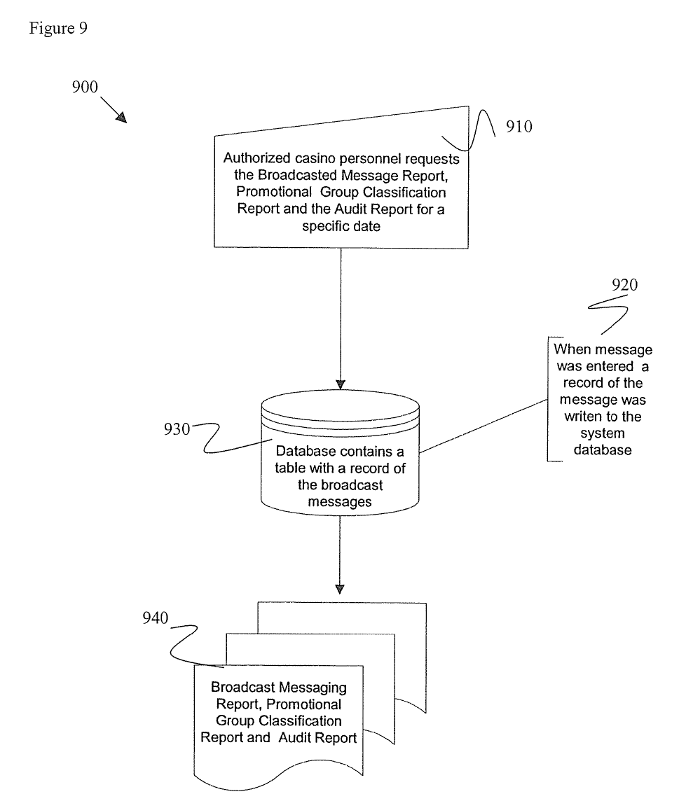

FIG. 9 illustrates a flow diagram for a method and system 900 for report generation used in accordance with an embodiment of the present invention. First, a request 910 for a report, such as a broadcast message report, a promotional group classification report, and/or an audit report, is entered. The report may be requested for a specific date, date range, patron, promotional group, or other criterion, for example. At 920, a record of a message is written to a database 930 when the message was generated. The database 930 includes a table or other data structure with a record of broadcast messages. The database 930 may also include other data. A report 940 is then generated from the data in database 930.

Thus, certain embodiments provide a system and method for allowing a gaming environment, such as a casino, to more effectively and efficiently notify patrons of promotional events. Authorized personnel enter a message into the system. For example, authorized casino personnel may use OASIS™ Super-PlayMate™ software to enter a message. The user may indicate a time for delivery when the message is entered. Alternatively, a time may automatically be determined (i.e., substantially real time) when the message is entered. At the indicated time, the system sends the message to the PBX hub via a gateway interface, for example. The PBX Hub then sends the message to personal communication devices. Thus, certain embodiments allow rapid and adaptive messaging to casino patrons to inform participating patrons of promotional events and changes to those events with minimal delay and overhead.

Certain embodiments allow casinos and other gaming establishments broadcast information regarding promotional events with increased effectiveness and efficiency. Certain embodiments allow a message to be entered and broadcast to one or more promotion notification devices. The message may remain on the notification device until removed by authorized personnel, a patron to whom the device is assigned, and/or a predefined period of time, for example.

While the invention has been described with reference to one or more preferred embodiments, those skilled in the art will understand that changes may be made and equivalents may be substituted without departing from the scope of the invention. In addition, many modifications may be made to adapt a particular step, structure, or material to the teachings of the invention without departing from its scope. Therefore, it is intended that the invention not be limited to the particular embodiment disclosed, but that the invention will include all embodiments falling within the scope of the appended claims.

What is claimed is:

1. An improve promotional messaging system, said system comprising:
a workstation configured to compose a promotional message for a gaining establishment; and
a message relay station for broadcasting said promotional message from said workstation to a registered communication device.

2. The system of claim 1, further comprising a communication device capable of receiving said message and displaying said message to a registered patron.

3. The system of claim 2, wherein said communication device comprises a promotion notification device assigned to a patron by said gaming establishment.

4. The system of claim 1, further comprising a server configured to store said promotional message.

5. The system of claim 4, wherein said server further comprises a database for storing said promotional message.

6. The system of claim 4, wherein said workstation is capable of generating a report using said promotional message stored at said server.

7. The system of claim 1, wherein said workstation is configured to allow an authorized user to at least one of edit and remove said promotional message before said promotional message is broadcast to said communication device.

8. The system of claim 1, wherein said workstation is configured to allow an authorized user to at least one of remove, edit and resend a promotional message that has previously been broadcast.

9. A promotional notification device, said device comprising:
a receiver for receiving a promotional message from a gaming environment relay station;
a display for displaying said promotional message; and
an alert indicator for alerting a user to receipt of said promotional message.

10. The promotional notification device of claim 9, wherein said alert indicator comprises at least one of an audio alert indicator, a visual alert indicator, and a vibrating alert indicator.

11. The promotional notification device of claim 9, further comprising a scrolling arrow capable of allowing a user to scroll through a message displayed on said display.

12. A computer-readable medium including a set of instructions capable of execution by a computer, said set of instructions comprising:
a message composition routine for composing a message for broadcast to at least one participating patron, wherein said message comprises a gaming promotional message;
a message broadcasting routine for retrieving communication information for said at least one participating patron and transmitting said message to said at least one participating patron using said communication information.

13. The set of instructions of claim 12, further comprising a messaging editing routine for at least one of editing, removing, recalling and resending said message.

14. The set of instructions of claim 12, further comprising a reporting routine for generating a report based on said message.

15. The set of instructions of claim 14, wherein said report comprises at least one of a broadcast messaging report, a player promotional messaging report, a promotional group report, an audit report and an error report.

16. A method for improved promotional broadcast messaging, said method comprising:
composing a promotional message for a gaming environment;
selecting one or more recipients for said promotional message;
associating contact information with said one or more recipients;
relaying said promotional message with said recipient contact information for broadcasting; and
broadcasting said promotional message to said one or more recipients using said recipient contact information.

17. The method of claim 16, wherein said contact information comprises a cellular phone number.

18. The method of claim 16, further comprising generating a status message when said promotional message is delivered to a communication device associated with said recipient contact information.

19. The method of claim 16, further comprising generating a report based on said promotional message.

20. The method of claim 16, further comprising at least one of editing, deleting, resending and recalling said promotional message.
